(19) United States
(12) Patent Application Publication
(10) Pub. No.: US 2010/0309435 A1
(43) Pub. Date: Dec. 9, 2010

(54) HIGH-QUALITY, NON-FLICKERING THREE-DIMENSIONAL IMAGE PROJECTION METHOD AND ITS SYSTEM

(75) Inventor: Sho-Chaug Sun, Taipei (TW)

Correspondence Address: HAMRE, SCHUMANN, MUELLER & LARSON, P.C., P.O. BOX 2902, MINNEAPOLIS, MN, 55402-0902, US

(73) Assignee: ViewSonic Corporation, Walnut, CA (US)

(21) Appl. No.: 12/478,263

(22) Filed: Jun. 4, 2009

(51) Int. Cl. G03B 21/00

(52) U.S. Cl. 353/7

(57) ABSTRACT

The preferred embodiment the invention presents pertains to a type of high-quality, non-flickering three-dimensional image projection method and its system, which mainly entails integrating a digital micromirror device (DMD) capable of processing 120 frames per second (120 fps) and a 120 fps three-dimensional analogical or digital image content to form a single surface DMD digital image projector for achieving a realistic, high-quality, non-flickering three-dimensional image viewing.

### THE TECHNICAL DOMAIN THE PROPOSED INVENTION FALLS UNDER

The preferred embodiment the invention presents pertains to a high-quality, non-flickering three-dimensional image projection method and its system, particularly referring to an application for receiving image signal content and a digital micromirror component in an identical high frequency to achieve a high-quality image, non-flickering projection method and its system with a three-dimensional perspective.

### PRIOR ART

With the present day's three-dimensional image projectors derived from integrating a number of technologies, one of the known three-dimensional project systems has utilized a digital image projector to achieve a non-flickering three-dimensional DVD movie playback of deinterlaced image, where the source of the image content has been the 30 frame-per-section (30 fps) deinterlaced format set by the National Television Standards Committee (NTSC). This requires incorporating the deinterlace process on an image projector or a playback device. Nevertheless, the deinterlace process tends to generate many image artifacts. As the frame speed per second deinterlaces at 60 fps, the weakened deinterlacing image content is then converted to twice the frame count per second of 120 fps to achieve a non-flickering effect; however, the initial image, which is derived from the NTSC's half frame count, suffers from internal weakening, blurring, and image artifacts to result in a lower image quality.

One other known three-dimensional image projection systems has the source image derived from a PC image to a digital 3D image projection device, where the source image content is kept to the line-scanning progressive format to rid of the image artifacts generated from the deinterlace process. Yet in light that the content is played back through a projection device, the lack of a deinterlacing or frame multiplying conversion tends to create unstable 3D flickering effect when the 60 fps image content is being played back.

Consequently, it beckons the need to further improve the three-dimensional image projection solution on the present day's industrial digital image projectors.

### CONTENT OF INVENTION

In light of the prior art's deficiencies, the inventor has devised a three-dimensional image projection method and its system to achieve the objective of prompting high-quality, non-flickering three-dimensional image.

The proposed invention, pertaining to a high-quality, non-flickering three-dimensional image projection method, which primarily entails integrating a digital micromirror device (DMD) capable of processing high-frequency image content and an analogical or digital line-scanning, high-frequency content at an identical high frequency, which is transmitted via an identical frequency to an image projector for playback to achieve a realistic, high-quality, non-flickering three-dimensional image viewing.

The invention, which pertains to a high-quality, non-flickering three-dimensional image projection system, is primarily consists of,

A PC or game console to prompt the line-scanning high-frequency image content;

An analogical signal of three primary colors of red, blue and green or a digital visual interface, or a digital micromirror device contained in a microdisplay panel capable of processing a high-definition multimedia image content for receiving and transmitting the high-frequency image content to an optical image projection device for prompting high-quality, non-flickering three-dimensional image playback.

### DESCRIPTION FOR ABRIDGED ILLUSTRATIONS

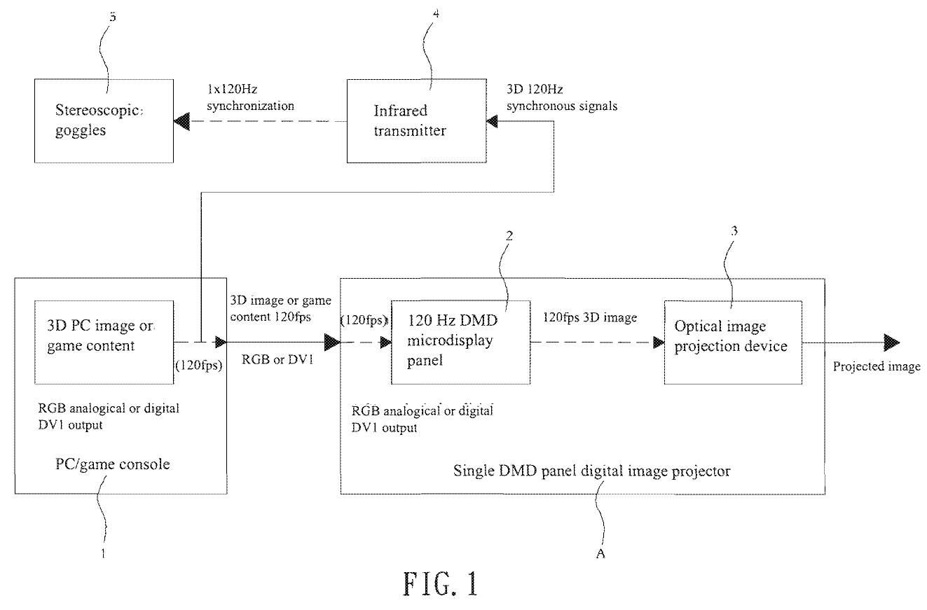

FIG. 1 depicts the invention's illustration system diagram

### IMPLEMENTATION METHOD

The preferred embodiment the invention presents pertains to a high-quality, non-flickering three-dimensional image projection method and its system, which has its key concept built upon combining a digital micromirror device (DMD) capable of processing high-frequency image content and a three-dimensional analogical or digital image content at an identical frequency, in which the image content has derived from a PC/game console to form a single surface DMD digital projection to achieve a realistic, high-quality, non-flickering three-dimensional image viewing.

The high-quality, non-flickering three-dimensional image projection method the invention presents has its tangible implementation lies in: provisioning 120 frame per second three-dimensional analogical signals or digital image content; transmitting said content via an analogical signal of three primary colors of red, blue and green (RGB), or a digital visual interface (DVI); provisioning a 120 fps digital micromirror device (DMD) for processing said image, and projecting said image through an optical image projector to prompt high-quality, non-flickering three-dimensional image.

For the makeup of a-more preferred implementation of a high-quality, non-flickering three-dimensional image projection system the invention presents, please refer to FIG. 1, which is comprised of,

The line-scanning 120 frame-per-second three-dimensional image or game content derived from a PC or game console (1), where the three-dimensional image content is transmitted through an analogical signal of primary three colors of red, blue and green, or a digital video interface (DVI), or a high-definition multimedia interface (HDMI) to a 120 fps DMD microdisplay panel (2), and the three-dimensional image is then projected onto an optical image projection device (3) for prompting a high-quality, non-flickering three-dimensional image playback. In which, the DMD display panel (2) and the optical image projection device (3) come to form a single DMD panel digital image projector (A).

In addition, to present the viewer with enhanced visual effect, it is viable to route the 120 fps synchronous signal from a PC or game console to an external infrared (IR) transmitter (4), where the infrared transmitter is used to transmit the 120 Hz image signal to the user's stereoscopic goggles (5).

The invention's high-quality, non-flickering three-dimensional image projection method and its system offers the following advantages and characteristics,

1. With the image source being a line scan, which signifies that it is a non-deinterlace mode, rather than the deinterlace image mode governed by the U.S. National Television Standards Committee, it stems from how the NTSC format, when applied in television broadcast and on DVD films, has its deinterlace formatted video signals transmitted only at one-half the screen image data at a time (the odd pixel screen or the even pixel screen) in order to conserve the frequency bandwidth. As this requires a certain type of deinterlace technology to integrate the odd pixel image and even pixel image together, the line-scanning mode indicates that all data are transmitted concurrently in a line-by-line manner, meaning that it is a line-scanning method rather than a deinterlace line-scanning method, thus adopting the line-scanning 120 fps image offers the advantage of a high-quality image.

2. The line-scanning mode offers a smooth, uninterrupted image quality, coordinated with 120 Hz image transmission, is able to achieve the non-flickering effect.

3. The adaptation of the 120 Hz DMD panel technology enables the realization of prompting the 120 Hz 3D image content.

As can be derived from the foregoing stated, the adaptation of the foresaid three-dimensional image projection method and its system is able to prompt a high-quality, non-flickering three-dimensional image viewing.

1. A high-quality, non-flickering three-dimensional image projection method, which primarily entails integrating a digital micromirror component capable of processing high-frequency image content and a three-dimensional analogical or digital line-scanning high-frequency image content in an identical high frequency, which is transmitted via the identical frequency to a projection equipment for projection, through which to achieve a realistic, high-quality, non-flickering three-dimensional image viewing.

2. As described in paragraph one of the scope of patent claim of a high-quality, non-flickering three-dimensional image projection method, in which the line-scanning high-frequency image content is of a 120 frame-per-section analogical or digital image content;

3. As described in paragraph one of the scope of patent claim of a high-quality, non-flickering three-dimensional image projection method, in which the transmission of the high-frequency image content has the image content transmitted through an analogical signal or three primary colors of red, blue and green (RGB) or a digital video interface;

4. As described in paragraph two of the scope of patent claim of a high-quality, non-flickering three-dimensional image projection method, in which the line-scanning high-frequency image content is routed to an external infrared (IR) transmitter via the identical 120 Hz synchronous signal, and the infrared transmitter then transmits the image to the user's stereoscopic goggles via the same 120 Hz image signal.

5. A high-quality, non-flickering three dimensional image project system, which is mainly comprised of a PC or game console to provide line-scanning, high-frequency image content;
An analogical of three primary colors of red, blue, green or a digital interface, or a high-definition multimedia slotted image interface to transmit the high-frequency image content; and,
A digital micromirror projection device in a microdisplay panel capable of processing identical high-frequency image content to receive the high-frequency image content and to transmit the content to an optical projection device, through which to provide the high-quality, non-flickering three-dimensional image playback.

6. As described in paragraph five of the scope of patent claim of a high-quality, non-flickering three-dimensional image projection method, in which the line-scanning high-frequency image content pertains to the 120 fps three-dimensional analogical signals or a digital image content; The high-frequency image content generated from the digital micromirror device is at 120 frames per second (fps).

7. As described in paragraph six of the scope of patent claim of a high-quality, non-flickering three-dimensional image projection method, in which it further incorporates a type of infrared (IR) transmitter signals, where said infrared synchronous transmitter receives the line-scanning high-frequency image content, which is then transmitter to a user's stereoscopic goggles via 120 Hz image signals.
